(19) United States
(12) Patent Application Publication
(10) Pub. No.: US 2007/0124311 A1
(43) Pub. Date: May 31, 2007

(54) System and method for providing web service to device without web browser

(75) Inventors: Kyung-eun Lee, Suwon-si (KR); Seung-hak Choi, Seongnam-si (KR); Do-wan Kim, Gunpo-si (KR); Chang-ki Choi, Seoul (KR); Su-myoung Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/520,612

(22) Filed: Sep. 14, 2006

(30) Foreign Application Priority Data
Nov. 29, 2005 (KR) 10-2005-0115077

(51) Int. Cl. G06F 17/30

(52) U.S. Cl. 707/10

(57) ABSTRACT

A system and a method for providing web services to a device without a web browser are provided. A client, which provides web services, includes a control module transmitting a user command to a server which has a web browser and which provides web services; a parsing module receiving a markup document and/or content from the server, and parsing the markup document and/or content, where the markup document and/or content are received from a web server by the web browser in response to the user command; and a content reproducing module reproducing the markup document and/or content, under control of the control module based on the parsing result.

### CROSS-REFERENCE TO RELATED PATENT APPLICATIONS

This application claims priority from Korean Patent Application No. 10-2005-0115077, filed on Nov. 29, 2005, in the Korean Intellectual Property Office, the disclosure of which is incorporated herein in its entirety by reference.

### BACKGROUND OF THE INVENTION

1. Field of the Invention

Systems and methods consistent with the present invention relate to web services, and more particularly, to providing web services to a device without a web browser.

2. Description of the Related Art

Development of home networks leads to researches into providing Internet services to various types of consumer electronics (CE) appliances, such as a television (TV) having a display and a refrigerator. However, memory and processor resources in the CE appliances are more seriously limited than in a personal computer (PC). Thus, it is difficult to install a web browser into a CE appliance so that the CE appliance can be connected to the Internet, and to provide web services to the CE appliance. In particular, since a conventional web browser engine for CE appliances does not support web technologies, such as ActiveX, which have been extensively used, services and content to be provided from a web server are limited.

Although systems that allow a CE device to use web services via a PC connected to a home network without a web browser have been developed, a web picture received from a PC is converted into an image, the image is transmitted to a CE device, and the CE device receives and displays the image. Therefore, it is difficult to provide video or interactive web services to the CE device.

### SUMMARY OF THE INVENTION

The present invention has been provided to address the above-mentioned and other problems and disadvantages. Exemplary embodiments of the present invention may overcome the above disadvantages and other disadvantages not described above. The present invention is not necessarily required to overcome any of the disadvantages described above, and the exemplary embodiments of the present invention may not overcome any of the problems described above. The appended claims should be consulted to ascertain the true scope of the invention.

The present invention provides a system and method for providing web services according to a simple application without a web browser that needs a large amount of system resources.

The present invention also provides a system and method for providing web services to a device without a web browser by receiving and displaying a markup document and content stored in a specific site via a server, such as a PC having a web browser, which can access the Internet.

The present invention also provides a computer readable medium having recorded the above-described method.

According to an aspect of the present invention, there is provided a client which provides web services, the client comprising a control module transmitting a user command to a server which has a web browser and provides web services; a parsing module receiving a markup document and/or content from the server, and parsing the markup document and/or content, where the markup document and/or content being received from a web server by the web browser in response to the user command; and a content reproducing module reproducing the markup document and/or content, under control of the control module based on the parsing result.

The parsing module may receive from the server only a result of reproducing the received markup document and/or content by the web browser.

The control module may determine arrangement of the markup document on a screen based on the parsing result, display the markup document, and instruct the content reproducing module to reproduce the content according to the arrangement.

The parsing module may include into the parsing result, information regarding only controls that perform a predetermined operation when a user selects the controls in the markup document.

The content reproducing module may comprise at least one of a text viewer displaying text data; a media player reproducing audio and/or video stream data; and an image viewer displaying image data.

The parsing module may exclude a predetermined type of control and/or content from the parsing result.

According to another aspect of the present invention, there is provided an interface between a web browser engine and a client which provides web services, the interface transmitting a user command received from the client to the web browser engine, and also transmitting, to a client, a markup document and/or content, which are received from a web server by the web browser engine in response to the user command.

The interface may include a first interface module transmitting the received user command to the web browser engine, outputting the received markup document and/or content, and obtaining and outputting audio and/or video data in a form of a stream. The audio and/or video data are included in the content and are reproduced by the web browser engine,. The interface may further include a second interface module transmitting the markup document and/or content received from the first interface module to the client, and outputting the user command received from the client to the first interface module.

The first interface module may capture frames of video data reproduced by the web browser engine and may generate the stream from the frames.

According to yet another aspect of the present invention, there is provided a method of providing web services, the method including transmitting a user command to a server that has a web browser and that provides web services; receiving, from the server, a markup document and/or content, which are received from a web server by the web browser in response to the user command. If the markup document is received, parsing the markup document, determining arrangement of the markup document on a screen based on the parsing result, and displaying the markup document. If the content is received, determining arrangement of the content on the screen, reproducing the content, and displaying the reproduced content according to the arrangement.

According to yet another aspect of the present invention, there is provided a method of interfacing between a web browser engine and a client that provides web services, comprising receiving a user command from the client; transmitting the user command to the web browser engine; obtaining a markup document and/or content in response to the user command. In this method, the markup document and/or content are being received from a web server by the web browser engine. Also, in this method, audio and/or video data, which are included in the content and reproduced by the web browser engine, may be obtained in a form of a stream. The method further includes transmitting the obtained markup document and/or the content to the client.

### BRIEF DESCRIPTION OF THE DRAWINGS

The above and other aspects of the present invention will become more apparent by describing in detail exemplary embodiments thereof with reference to the accompanying drawings in which:

FIG. 1 is a block diagram of a system for providing web services according to an exemplary embodiment of the present invention;

FIG. 2 is a block diagram of a server for providing web services according to an exemplary embodiment of the present invention;

FIG. 3 is a block diagram of a client for providing web services according to an exemplary embodiment of the present invention;

FIG. 4 is a flowchart illustrating a method of providing web services according to an exemplary embodiment of the present invention; and

FIG. 5 is a flowchart illustrating an interface method of providing web services according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. Same reference numerals denote analogous elements throughout the drawings and the detailed description of the exemplary embodiments.

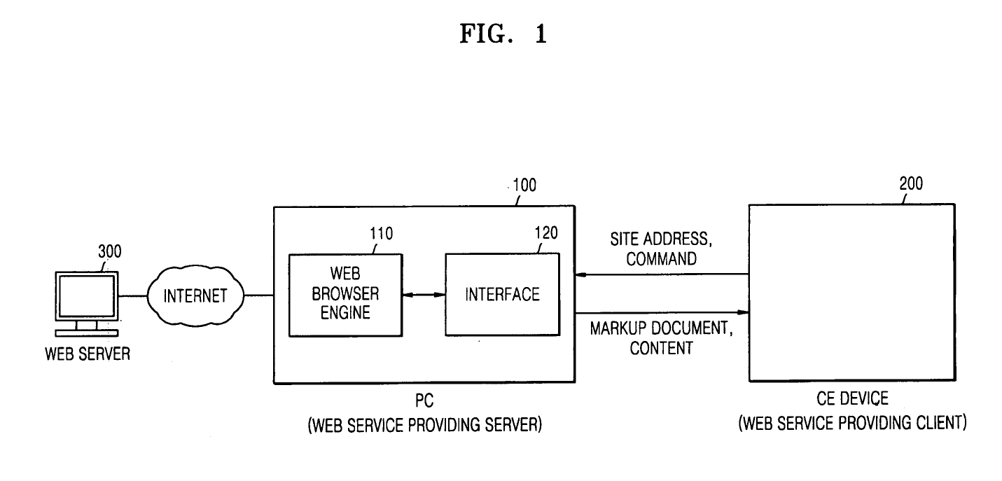

FIG. 1 is a block diagram of a system for providing web services according to an exemplary embodiment of the present invention. Referring to FIG. 1, a server 100, e.g., PC, provides web services in a home network. The server 100 is a general computing system having a web browser engine 110, which can be connected to the Internet. The server 100 receives and reproduces a markup document and content from a web server 300 via the Internet. To provide web services, the server 100 includes a web browser engine 110, and an interface 120 that interfaces with a client 200, such as a CE device, which is a web service providing client. The interface 120 receives a user command, such as a web site address, from the client 200, and transmits the received command to the web browser engine 110. The interface 120 further transmits to the client 200 information that the web browser engine 110 receives via the Internet in response to the user command. In this case, the interface 120 provides the client 200 with only a result of reproducing the received information by the web browser engine 110. In other words, a reproduction stream of audio and/or video data, a result of executing an ActiveX control or a Java script, or content such as an image or a text are transmitted together with a markup document to the client 200, and therefore, the client 200 can provide web services without a module, such as ActiveX engine, a Java script engine, or a decoder for video files, which need a large amount of resources. That is, the client 200 may provide web services without the web browser.

The client 200, which allows a user to view web pictures, parses the markup document received from the server 100, rearranges and displays elements included in the markup document, and reproduces audio/video data along with the markup document.

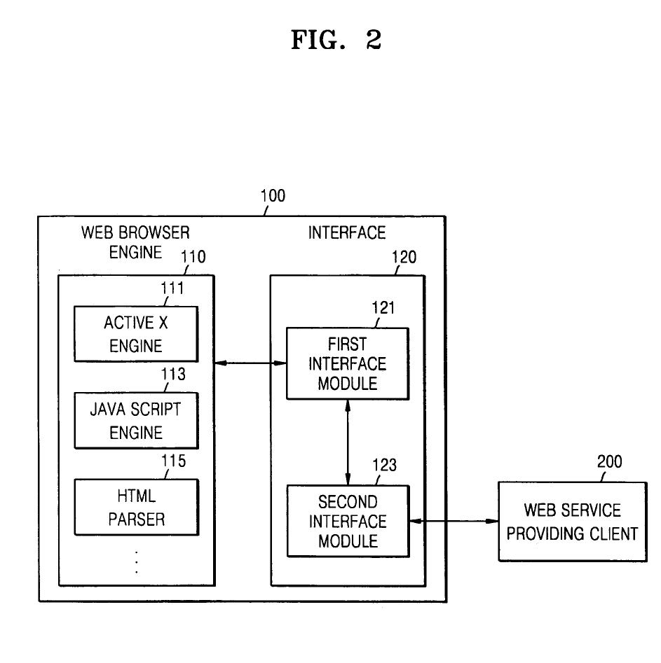

FIG. 2 is a detailed block diagram of the server 100 according to an exemplary embodiment of the present invention. Referring to FIG. 2, the web browser engine 110 includes an ActiveX engine 111 that executes ActiveX control, a Java script engine 113 that executes Java script, and a hypertext markup language (HTML) parser 115 that parses a markup document such as an HTML document.

The interface 120 includes a first interface module 121 that performs a function similar to operating of a web browser in a PC and exchanges data with the web browser engine 110, and a second interface module 123 that exchanges data with the client 200. The second interface module 123 receives a user command, such as a web site address or control selection, from the client 200, and transmits it to the first interface module 121. If the first interface module 121 transmits the user command to the web browser engine 110, the web browser engine 110 receives a markup document and/or content which correspond(s) to a user command via the Internet. The first interface module 121 outputs the markup document and/or content, which are received from the web browser engine 110 to the second interface module 123, and the second interface module 123 transmits the markup document and/or content to the client 200. In particular, in the case of audio and/or video data reproduced by the web browser engine 110, the first interface module 121 obtains and outputs the audio and/or video data in the form of a stream. If the audio and/or video data cannot be obtained in the form of a stream, the first interface module 121 captures frames of the reproduced video data, generates a stream from the frames, and outputs the generated stream.

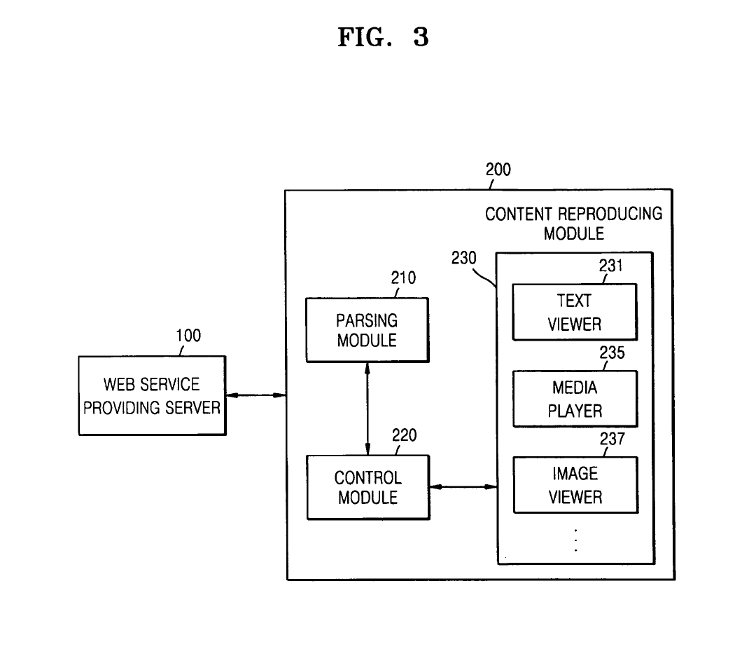

FIG. 3 is a detailed block diagram of the client 200 according to an exemplary embodiment of the present invention. Referring to FIG. 3, the client 200 includes a parsing module 210, a control module 220, and a content reproducing module 230.

When a user inputs a web site address via an input unit (not shown) or clicks a button on a screen, the control module 220 transmits a command corresponding to the user's input or selection, to the server 100. The parsing module 210 receives a markup document and content from the server 100, parses the received markup document, and transmits the parsing result and the content to the control module 220. The control module 220 determines arrangement of the markup document on a screen and displays the markup document based on the parsing result from the parsing module 210, and instructs the content reproducing module 230 to reproduce the content. The content reproducing module 230 includes a text viewer 231 that displays text data, a media player 235 that reproduces audio and/or video stream data, and an image viewer 237 that displays image data.

It is possible to ignore certain elements (bgcolor, font, etc.) needed to decorate a web page, and transmit information regarding only the control elements of the markup document, to the control module 220, in consideration of the performance of the client 200, which is a CE device. A control is an element, such as a button or a list, which performs a predetermined operation when a user selects the control. For example, it is assumed that the received markup document has the following:

<a id=2a class=q href=“http://news.google.co.kr/nwshp?hl=ko&tab=wn” onClick=“return qs(this);”>news</a>&nbsp;&nbsp;&nbsp;&nbsp;

The parsing module 210 parses this received markup document and transmits only “news” and “http://news.google.co.kr/nwshp?hl=ko&tab=wn” to the control module 220. Then, the control module 220 displays a button corresponding to the “news” on the screen. If a user clicks the button “news”, a command that requests a connection with “http://news.google.co.kr/nwshp? hl=ko&tab=wn” is transmitted to the server 100.

If a web page corresponding to “http://news.google.co.kr/nwshp? hl=ko&tab=wn” contains video information, the parsing module 210 receives content in a stream data format from the server 100 and transmits it to the control module 220. The control module 220 instructs the media player 235 to reproduce the stream. The control module 220 instructs the text viewer 231 to display text data in the web page and the image viewer 237 to display image data in the web page. Thus, the web page corresponding to http://news.google.co.kr/nwshp?hl=ko&tab=wn is rearranged and displayed on the screen according to the arrangement of the markup document on the screen as determined by the control module 220.

All of web services may not be received due to the limited display resources and low computing power of the client 200. In this case, the parsing module 210 may include the necessary items into the parsing result and transmits the parsing result to the control module 220, so that only necessary information is extracted from the received markup document and content, and is displayed on the screen. For instance, only information regarding the control may be transmitted to the control module, as described above. Also, unwanted information such as an advertisement may be excluded from the parsing result and not displayed

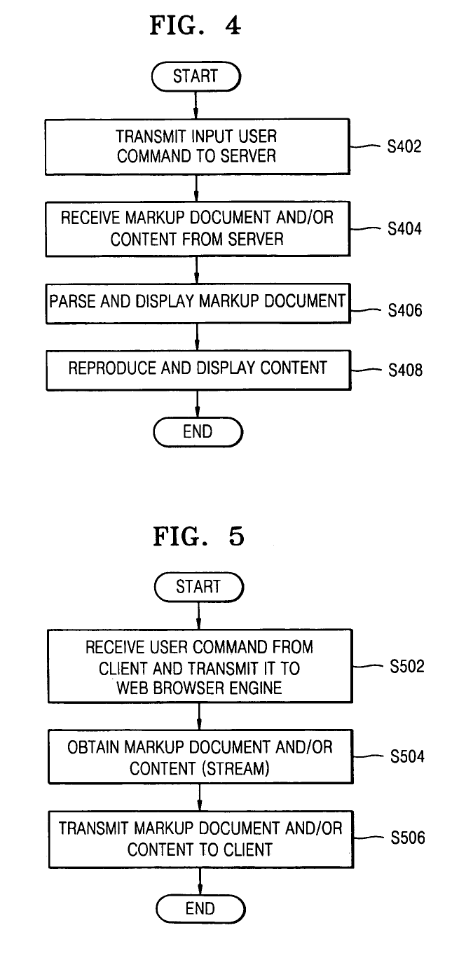

FIG. 4 is a flowchart illustrating a method of providing web services according to an exemplary embodiment of the present invention. Referring to FIG. 4, when a user command is input via an input unit of a client that provides web services, the input user command is transmitted to a server (S402). The user command is input by selecting a web access menu or by inputting a web site address on a screen, or by clicking or selecting a control such as button in a current web page. Next, a web browser engine of the server receives a markup document and/or content corresponding to the user command via the Internet, and the client receives the markup document and/or the content via an interface interlocked with the web browser engine (S404). If the markup document is received, the markup document is parsed, and the arrangement of the markup document on a screen is determined based on the parsing result. Then, the markup document is displayed (S406). Information regarding only controls may be transmitted as the parsing result and displayed. If the content is received, arrangement of the content on the screen is determined and the content is reproduced and displayed (S408). As a result, a user can view a web page displaying the markup document and the content. Furthermore, if the user selects a control displayed in the web page or inputs an address, the method of FIG. 4 proceeds to operation S402.

FIG. 5 is a flowchart illustrating an interface method of providing web services according to an exemplary embodiment of the present invention. First, an interface that provides web services receives a user command from a client that provides web services and transmits the received user command to a browser engine (S502). The web browser engine receives a markup document and content corresponding to the user command via the Internet. If audio and/or video data are transmitted from the web server and reproduced by the web browser engine, the interface obtains the reproduced audio and/or video data in a form of a stream, or captures frames of the reproduced audio and/or video data and generates a stream from the frames (S504). Lastly, the interface transmits the obtained or generated markup document and/or content to the client (S506).

An exemplary embodiment of the present invention may be embodied as computer readable code in a computer readable medium.

As described above, according to the exemplary embodiments of the present invention, it is possible to provide web services using a simple application program that does not increase the load on a device. The web services may be provided to a device without a web browser, e.g., a device without modules such as an ActiveX engine or a Java script engine, which need a large amount of computing resources.

Also, it is possible to selectively provide a user with only web services or information that the user wants, thereby efficiently providing services to a device irrespective of the display performance of the device.

Also, a plurality of CE devices connected to a PC in a home network can provide services at the same time, and it is possible to provide different web services according to the characteristics of a device and/or user's settings.

While the exemplary, non-limiting embodiments of the present invention have been particularly described and shown with reference to the accompanying drawings, it will be understood by those skilled in the art that various changes in form and details may be made therein without departing from the spirit and scope of the invention as defined by the appended claims and their equivalents.

What is claimed is:

1. A client which provides web services, the client comprising:
a control module which transmits a user command to a first server, wherein the first server includes a web browser and provides web services;
a parsing module which receives data comprising at least one of a markup document and content from the first server, and parses the received data, wherein the data is received from a web server by the web browser of the first server in response to the user command; and
a content reproducing module which reproduces the data under control of the control module based on a parsing result of the parsing module.

2. The client of claim 1, wherein the parsing module receives from the first server only a result of reproducing the data by the web browser of the first server.

3. The client of claim 2, wherein the control module determines an arrangement of the markup document on a screen based on the parsing result, displays the markup document, and instructs the content reproducing module to reproduce the content according to the arrangement.

4. The client of claim 3, wherein the parsing result includes only information regarding controls that perform an operation if a user selects the controls in the markup document.

5. The client of claim 4, wherein the content reproducing module comprises at least one of:
a text viewer which displays text data;
a media player which reproduces audio or video stream data; and
an image viewer which displays image data.

6. The client of claim 4, wherein the parsing module excludes from the parsing result at least one of a type of control and content.

7. An interface implemented on a computer between a web browser engine and a client which provides web services, the interface comprising:
a transmitting module which transmits a user command received from the client to the web browser engine, and transmits to the client at least one of a markup document and content, which are received from a web server by the web browser engine in response to the user command.

8. The interface of claim 7, comprising:
a first interface module which transmits the received user command to the web browser engine, which outputs the received at least one of the markup document and content, and obtains and outputs at least one of audio and video data in a form of a stream, wherein the at least one of audio and video data is included in the content and is reproduced by the web browser engine; and
a second interface module which transmits to the client the at least one of markup document and content received from the first interface module, and outputs the user command received from the client to the first interface module.

9. The interface of claim 8, wherein the first interface module only outputs a result of reproducing, by the web browser engine, the at least one of markup document and content.

10. The interface of claim 9, wherein the first interface module captures frames of video data reproduced by the web browser engine and generates the stream from the frames.

11. A method of providing web services, the method comprising:
transmitting a user command to a first server that includes a web browser and provides web services;
receiving, from the first server, data comprising at least one of a markup document and content, which is received from a web server by the web browser in response to the user command;
if the markup document is received, parsing the markup document, determining arrangement of the markup document on a screen based on a result of the parsing, and displaying the markup document; and
if the content is received, determining arrangement of the content on the screen, reproducing the content, and displaying the reproduced content according to the arrangement.

12. The method of claim 11, wherein the receiving of the data comprises receiving only a result of reproducing the data by the web browser.

13. The method of claim 12, wherein the parsing and displaying of the markup document comprises:
generating, as the result of the parsing, only information regarding controls, which perform a predetermined operation if a user selects the controls; and
displaying the information regarding the controls.

14. The method of claim 13, wherein the parsing and displaying of the markup document further comprises excluding displaying information regarding a predetermined type of control, and
the reproducing and displaying of the content comprises excluding displaying a predetermined type of content.

15. A method of interfacing between a web browser engine and a client that provides web services, the method comprising:
receiving a user command from the client;
transmitting the user command to the web browser engine;
obtaining data comprising at least one of a markup document and content in response to the user command, wherein the data is received from a web server by the web browser engine, and at least one of audio and video data, which are included in the content and reproduced by the web browser engine, is obtained in a form of a stream; and
transmitting the obtained data to the client.

16. The method of claim 15, wherein the obtaining of the data comprises obtaining only a result of reproducing the received data by the web browser engine.

17. The method of claim 16, wherein the obtaining of the data further comprises capturing frames of the video data reproduced by the web browser engine and generating the stream from the frames.

18. A computer readable medium having recorded a program for executing a method of providing web services, the method comprising:
transmitting a user command to a first server that includes a web browser and provides web services;
receiving, from the first server, data comprising at least one of a markup document and content, which are received from a web server by the web browser in response to the user command;
if the markup document is received, parsing the markup document, determining arrangement of the markup document on a screen based on a result of the parsing, and displaying the markup document; and
if the content is received, determining arrangement of the content on the screen, reproducing the content, and displaying the reproduced content according to the arrangement.

19. A computer readable medium having recorded a program for executing an interface method of interfacing between a web browser engine and a client that provides web services, the method comprising:
receiving a user command from the client;
transmitting the user command to the web browser engine;
obtaining data comprising at least one of a markup document and content in response to the user command, wherein the data is received from a web server by the web browser engine, and at least one of audio and video data, which is included in the content and which is reproduced by the web browser engine, is obtained in a form of a stream; and
transmitting the obtained data to the client.
